(19) United States
(12) Patent Application Publication
(10) Pub. No.: US 2025/0263845 A1
(43) Pub. Date: Aug. 21, 2025

(54) Apparatus and method for the production of hydrogen

(71) Applicant: Christoph Hohl, Hahnbach (DE)

(72) Inventor: Christoph Hohl, Hahnbach (DE)

(21) Appl. No.: 19/007,996

(22) Filed: Jan. 2, 2025

(30) Foreign Application Priority Data
Feb. 4, 2024 (DE) 102024000360.6

(51) Int. Cl. C25B 1/04

(52) U.S. Cl. CPC C25B 1/04

(57) ABSTRACT

The invention relates to a method and an apparatus for the production of hydrogen from a hydrogen-containing substance by splitting the hydrogen-containing substance into its components, wherein the hydrogen-containing substance is stimulated by means of an electromagnetic wave generator. The electromagnetic wave generator emits energy at the resonant frequency of an atomic bond of the hydrogen-containing substance. According to the invention, it is provided that the splitting of the hydrogen-containing substance takes place in an electromagnetic resonator.

The present invention relates to a process and an apparatus for the efficient production of hydrogen. A specially adapted device and the use of electromagnetic radiation with a wavelength in the range of the resonance frequency of the atomic bond of a hydrogen-containing substance increase the efficiency of the splitting of the hydrogen-containing substance.

### BACKGROUND

Hydrogen production can become a key technology for the energy crisis and climate change. In order to produce hydrogen efficiently, the efficiency of the conventional production process, the electrolysis, must be significantly improved. The improvement in efficiency enables more cost-effective production and therefore many new uses for hydrogen in industry, aerospace and the private sector.

US 2013/0134046 A1 discloses a device and a method for increasing the production of hydrogen during electrolysis. First, a vibration mode of the electrolyte liquid is determined. Then a laser is tuned to the wavelength close to the selected vibration mode. A tuned laser is then applied to the electrolyte liquid. The application of the laser with a wavelength close to the wavelength of a specific vibration mode of the electrolyte liquid results in an increase in the production rate of hydrogen, compared to electrolysis alone. The specific vibration mode may correspond to a mode that stretches the inter atomic bonds of hydrogen in the electrolyte liquid.

It is an object of the present invention to provide an improved method and apparatus for producing hydrogen more efficiently.

One aspect of the present invention is the use of an electromagnetic wave at the resonance frequency of the atomic bond between, for example, OH or CH compounds. The resonance frequency depends on the spatial arrangement of the atoms to be separated. For example, the resonance frequency with a wave number of 3657/cm is used to produce pure hydrogen from the basic medium of water. The electromagnetic wave at the resonance frequency causes the atomic bond to be destroyed by a resonance catastrophe. The hydrogen and oxygen atoms of the water molecule are splitted and then separated by a static electric field.

There are several ways to generate an electromagnetic wave and these are listed below:
1. laser at the resonant frequency
2. further development of the magnetron (traveling wave tubes)
3. heat/infrared source with subsequent filtering

### PROBLEM AND ITS SOLUTION

The problem with the known method lies in the difficult-to-control electromagnetic wave and its precise effect. The efficiency of the method described here is increased by using a cavity resonator that is tuned to the resonance frequency of the medium used. A deviation in the irradiating frequency or irradiation with a broad spectrum of frequencies reduces the efficiency of the system. By using a cavity resonator, which is designed for the resonance frequency of the medium, the other frequencies apart from the resonance frequency are suppressed, thereby significantly increasing the efficiency of the system.

To maximize the efficiency and focus the effect, it is suggested that the separation of the medium (e.g. water) is operated in a cavity resonator. Cavity resonators are usually used in high-frequency technology. When using a cavity resonator, the electromagnetic wave is forced to form a standing wave in the resonator.

To improve efficiency, the cavity resonator is tuned to the resonant frequency of the covalent bond of the hydrogen-containing substance. The separation of the medium then takes place within the resonator. As the energy of the electromagnetic wave is concentrated in the resonator and not radiated, the separation of the hydrogen-containing substance can be achieved here with a high degree of efficiency. This means that a lot of energy can be introduced into the resonator with low losses. The efficiency of the chemical splitting of the hydrogen-containing substance is increased.

Depending on the material properties of the hydrogen-containing substance to be split, the mechanical size of the resonator must be adapted. However, a cavity resonator with higher modes can also be used to achieve a mechanically feasible size. In general, it should be noted that all n-fold and 1/n-fold (n element of all natural numbers) of the characteristic resonance wavelength of the atomic bond of the hydrogen-containing substance can be used.

An electric field is used to separate the components of the split hydrogen-containing substance. However, this is only required for the separation, but not for the splitting.

The problem of the invention is solved by the independent claims.

Advantageous embodiments of the invention are the subject of the sub claims.

The invention relates to a process for producing hydrogen from a hydrogen-containing substance by splitting the hydrogen-containing substance into its components, wherein the hydrogen-containing substance is stimulated by means of an electromagnetic wave generator. The electromagnetic wave generator emits energy at the resonant frequency of an atomic bond of the hydrogen-containing substance. According to the invention, it is provided that the splitting of the hydrogen-containing substance takes place in an electromagnetic resonator.

In particular, the electromagnetic resonator is a cavity resonator.

In a further development of the method, the geometry of the electromagnetic resonator is designed for the resonant frequency of the atomic bond of the hydrogen-containing substance.

Advantageously, the geometry of the electromagnetic resonator is designed for an n-fold or a 1/n-fold of the resonant frequency of the atomic bond of the hydrogen-containing substance, so that a realistically producible size is achieved.

The invention further relates to an apparatus for producing hydrogen. The apparatus comprises:
an electromagnetic resonator which is filled with a hydrogen-containing substance;
an anode and a cathode which are connected to a power supply and are in electrical contact with the hydrogen-containing liquid;
an electromagnetic wave generator designed to generate electromagnetic waves at the resonant frequency of the hydrogen-containing substance;
an inlet for the hydrogen-containing substance and
at least one outlet for a decomposed hydrogen-containing substance.

In particular, the electromagnetic resonator is a cavity resonator.

In one embodiment, the electromagnetic wave generator is a laser, a magnetron, or a heat source.

In an advantageous embodiment, the geometry of the electromagnetic resonator is designed for the resonant frequency of the atomic bond of the hydrogen-containing substance or for an n-fold or a 1/n-fold of the resonant frequency of the atomic bond of the hydrogen-containing substance.

Embodiments of the invention are explained in more detail below with reference to drawings.

They show

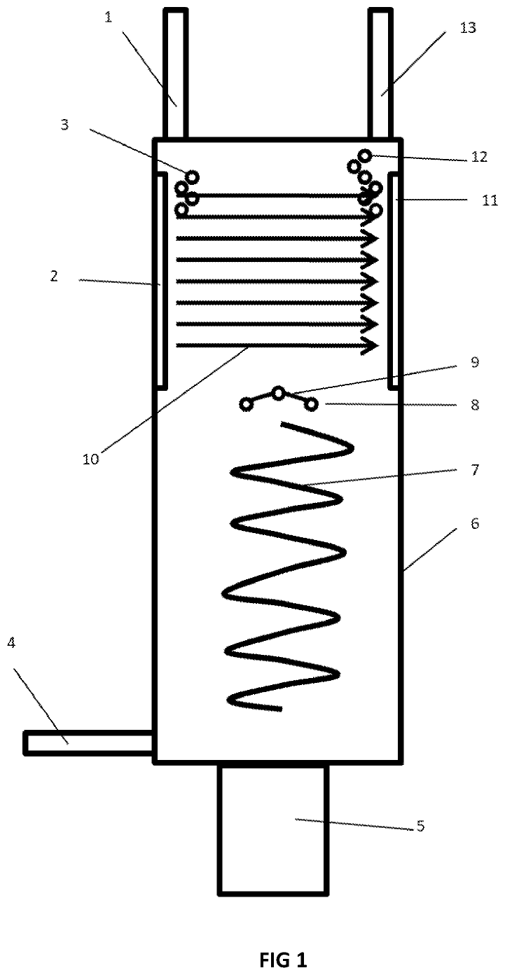

FIG. 1 Schematic structure of the device according to the invention for the production of hydrogen

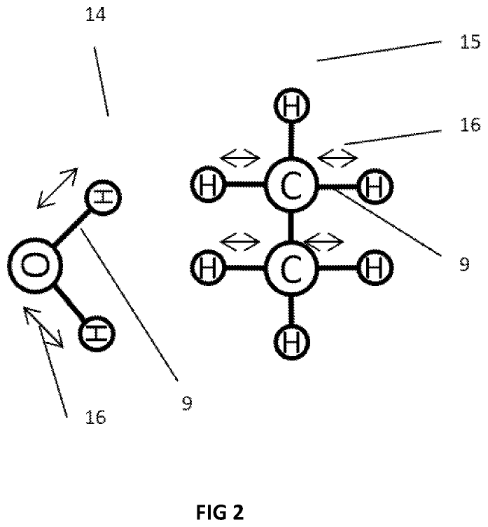

FIG. 2 Schematic representation of the molecular structure of a water molecule and an ethane molecule

FIG. 1 shows a possible device for splitting a hydrogen-containing substance 8 in a cavity resonator 6. A hydrogen-containing substance 8, such as water, is fed into a cavity resonator 6 via an inlet 4. The geometry of the cavity resonator 6 is designed to match the resonant frequency of the atomic bond 9 of the water. The specially designed geometry of the cavity resonator 6 enables a standing electromagnetic wave 7 in the cavity resonator 6 at the resonant frequency of the water. By linearly increasing the underlying output geometry of the cavity resonator 6, the number of maxima of the standing electromagnetic wave 7 is increased. For example, a 1000-fold larger geometry of the underlying cavity resonator 6 is used in order to achieve a realistically manufacturable size. The standing electromagnetic wave 7 is generated by the high-frequency source 5, such as a laser or traveling wave tube, and fed into the cavity resonator 6. At the maxima of the standing electromagnetic wave 7, the atomic bond 9 of the hydrogen-containing substance 8 is stimulated and destroyed by a resonance catastrophe. The hydrogen-containing substance 8 is splitted into its constituent parts, partial substance A 3 and partial substance B 12. Partial substance A 3 and partial substance B 12, such as hydrogen and oxygen in this example, are present as charged ions after the molecule has been splitted and are separated by a static electric field 10. The static electric field 10 is generated by an applied voltage between anode 2 and cathode 11. At anode 2 and cathode 11, the partial substance A ions and partial substance B ions are converted into partial substance A 3 molecules and partial substance B 12 molecules. In the specific example with water, hydrogen and oxygen ions are converted into hydrogen and oxygen molecules. Partial substance A 3 and partial substance B 12 are discharged via outlet A 1 and outlet B 13. In the specific example with water, hydrogen and oxygen are discharged via outlets A 1 and B 13.

FIG. 2 shows a water molecule 14 and an ethane molecule 15 in their molecular structure. The atomic bond 9 is destroyed by stimulation by an electromagnetic wave 7 at the resonance frequency of the atomic bond 9. The resulting movement 16 between the atoms ultimately ends in a resonance catastrophe. This leads to the destruction of the atomic bond 9.

To stimulate the resonance of the atomic bond 9 in a water molecule 14, for example, a wave number of 3657 cm-1 is required for symmetrical stretching of the atomic bonds 9 of water, which corresponds to the frequency of 17.45 THz.

### LIST OF REFERENCE NUMBERS

1. outlet A
2. anode
3. partial substance A
4. inlet
5. high frequency source
6. cavity resonator
7. standing electromagnetic wave
8. hydrogen-containing substance
9. atomic bond
10. static electric field
11. cathode
12. partial substance B
13. outlet B
14. water molecule
15. ethane molecule
16. movement

1. Method for the production of hydrogen from a hydrogen-containing substance by splitting the hydrogen-containing substance into its constituent parts, the hydrogen-containing substance being stimulated by means of an electromagnetic wave generator, the electromagnetic wave generator emitting energy at the resonant frequency of an atomic bond of the hydrogen-containing substance,
characterized in
that the splitting of the hydrogen-containing substance takes place in an electromagnetic resonator.

2. Method according to claim 1, characterized in that the electromagnetic resonator is a cavity resonator.

3. Method according to claim 1, characterized in that the geometry of the electromagnetic resonator is designed for the resonant frequency of the atomic bond of the hydrogen-containing substance.

4. Method according to claim 3, characterized in that the geometry of the electromagnetic resonator is designed for an n-fold or a 1/n-fold of the resonant frequency of the atomic bond of the hydrogen-containing substance.

5. Apparatus for producing hydrogen comprising:
an electromagnetic resonator filled with a hydrogen-containing substance; an anode and a cathode which are connected to a power supply and are in electrical contact with the hydrogen-containing liquid; an electromagnetic wave generator designed to generate electromagnetic waves at the resonant frequency of the hydrogen-containing substance; an inlet for the hydrogen-containing substance and an outlet for a decomposed hydrogen-containing substance.

6. Apparatus according to claim 5, characterized in that the electromagnetic resonator is a cavity resonator.

7. Apparatus according to claim 5, characterized in that the electromagnetic wave generator is a laser, a magnetron, or a heat source.

8. Apparatus according to claim 5, characterized in that the geometry of the electromagnetic resonator is designed for the resonant frequency of the atomic bond of the hydrogen-containing substance or for an n-fold or a 1/n-fold of the resonant frequency of the atomic bond of the hydrogen-containing substance.
